(19) United States
(12) Patent Application Publication
(10) Pub. No.: US 2026/0292671 A1
(43) Pub. Date: Sep. 24, 2026

(54) PUBLIC LAND MOBILE NETWORK (PLMN) SCANNING FOR INTERNET OF THINGS (IOT) DEVICES DURING INTERNATIONAL MOBILITY

(71) Applicant: QUALCOMM Incorporated, San Diego, CA (US)

(72) Inventors: Sohrab AHMAD, Hyderabad (IN); Abhishek BHATNAGAR, San Diego, CA (US); Osama LOTFALLAH, San Diego, CA (US); Raghuveer Ramakrishna Srinivas TARIMALA, Hyderabad (IN); Bhanu Kiran JANGA, Hyderabad (IN); Rishika TINDOLA, Hyderabad (IN); Nilotpal DHAR, Hyderabad (IN); Muralidharan MURUGAN, Hyderabad (IN); Prabhanjan Reddy PINGILI, Hyderabad (IN); Andrzej YURKEVICH, San Diego, CA (US)

(21) Appl. No.: 19/477,462

(22) PCT Filed: Jun. 14, 2024
(86) PCT No.: PCT/US2024/034137

§ 371 Date: Oct. 21, 2025

(30) Foreign Application Priority Data
Jun. 28, 2023 (IN) 202341043409

(51) Int. Cl. H04W 48/18; H04W 60/04

(52) U.S. Cl. CPC H04W 48/18; H04W 60/04

(57) ABSTRACT

A method for wireless communication by a user equipment (UE) includes configuring pairs of radio access technologies (RATs) and frequency bands in response to detecting no preferred public land mobile network (PLMN) while the UE is roaming in a different country than a country in which the UE was previously registered. The method also includes scanning one of the pairs of RAT/frequency band in a selected PLMN. The method further includes attempting registration on the selected PLMN in response to the scanning indicating a quality of the selected PLMN is above a threshold. The method includes storing the selected PLMN in a list of successful PLMNs in response to successful registration.

### CROSS-REFERENCE TO RELATED APPLICATION

The present application claims priority to Indian Patent Application No. 202341043409, filed on Jun. 28, 2023, and titled “PUBLIC LAND MOBILE NETWORK (PLMN) SCANNING FOR INTERNET OF THINGS (IOT) DEVICES DURING INTERNATIONAL MOBILITY,” the disclosure of which is expressly incorporated by reference in its entirety.

### TECHNICAL FIELD

The present disclosure relates generally to wireless communication, and more specifically to improving the public land mobile network (PLMN) camping time for Internet of things (IOT) devices when roaming.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method for wireless communication by a user equipment (UE) includes configuring pairs of radio access technologies (RATs) and frequency bands in response to detecting no preferred public land mobile network (PLMN) while the UE is roaming in a different country than a country where the UE was previously registered. The method also includes scanning one of the pairs of RAT/frequency band in a selected PLMN. The method further includes attempting registration on the selected PLMN in response to the scanning indicating a quality of the selected PLMN is above a threshold. The method includes storing the selected PLMN in a list of successful PLMNs in response to successful registration.

Other aspects of the present disclosure are directed to an apparatus. The apparatus has a memory and one or more processors coupled to the memory. The processor(s) is configured to configure pairs of radio access technologies (RATs) and frequency bands in response to detecting no preferred public land mobile network (PLMN) while the UE is roaming in a different country than a a country where the UE was previously registered. The processor(s) is also configured to scan one of the pairs of RAT/frequency band in a selected PLMN. The processor(s) is further configured to attempt registration on the selected PLMN in response to the scanning indicating a quality of the selected PLMN is above a threshold. The processor(s) is also configured to store the selected PLMN in a list of successful PLMNs in response to successful registration.

Other aspects of the present disclosure are directed to an apparatus. The apparatus includes means for configuring pairs of radio access technologies (RATs) and frequency bands in response to detecting no preferred public land mobile network (PLMN) while the UE is roaming in a different country than a country where the UE was previously located. The apparatus also includes means for scanning one of the pairs of RAT/frequency band in a selected PLMN. The apparatus further includes means for attempting registration on the selected PLMN in response to the scanning indicating a quality of the selected PLMN is above a threshold. The apparatus also includes means for storing the selected PLMN in a list of successful PLMNs in response to successful registration.

In other aspects of the present disclosure, a non-transitory computer-readable medium with program code recorded thereon is disclosed. The program code is executed by a processor and includes program code to configure a number of pairs of radio access technologies (RATs) and frequency bands in response to detecting no preferred public land mobile network (PLMN) while the UE is roaming in a different country than a country where the UE was previously located. The program code also includes program code to scan one of the pairs of RAT/frequency band in a selected PLMN. The program code further includes program code to attempt registration on the selected PLMN in response to the scanning indicating a quality of the selected PLMN is above a threshold. The program code also includes program code to store the selected PLMN in a list of successful PLMNs in response to successful registration.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects.

The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a table illustrating neighbor mobile country codes (MCCs), in accordance with various aspects of the present disclosure.

FIG. 5 is a flow diagram illustrating a method for public land mobile network (PLMN) scanning, in accordance with various aspects of the present disclosure.

FIG. 6 is a flow diagram illustrating an example process performed, for example, by a user equipment (UE), in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Internet of things (IOT) devices may include various types of devices, such as tracking devices. A tracking device may have sensor capabilities that track environmental conditions and locations of assets. These devices are generally lightweight and low power. Some tracking devices may transmit geolocation data in real time.

In some scenarios, a tracker device moves from one region (e.g., mobile country code (MCC) or country) to another. For example, in the European Union, a tracking device may cross multiple regions in a single trip. When moving from one region to another, especially while recovering from an out-of-service (OOS) state or coming online after power up, scanning for a network may take a long time. The scanning may be lengthy, for example, when the user equipment (UE) is in a country while roaming or in a country with a worldwide MCC (e.g., 9xx), such that the UE does not have a preferred public land mobile network (PLMN) in this country.

According to aspects of the present disclosure, the UE stores a table in memory that helps the UE detect a county change based on neighboring countries. The UE detects whether a country change has occurred after a certain duration. For example, the UE may detect whether a country change has occurred in response to an expiration of a configurable timer, while performing a first round of scans. If any neighbors of the requested PLMN are found in the table, the UE continues the scan. If no neighbors are found from the configured table, the UE aborts the ongoing scan because the UE determines the country has changed and the UE is in a roaming scenario.

If the UE is in a roaming scenario, the UE determines whether a preferred PLMN exists. If so, the UE attempts to register on the preferred PLMN. If no preferred PLMN exists, the UE restarts PLMN selection by randomizing the radio access technologies (RATs) and bands supported by the UE. The UE will then restart scanning based on the randomized RAT/band pairs. If service is found and the UE successfully registers on a PLMN, the successful PLMN is stored in a cache for later use, such as the next time the UE returns from an out-of-service state while roaming. If service is not found, the UE may enter an out-of-service state.

Particular aspects of the subject matter described in this disclosure can be implemented to realize one or more of the following potential advantages. In some examples, the described techniques may enable fast recovery in cases when a UE moves from one country to another. As a result, a better end user experience and longer device battery life are achieved as the PLMN scanning time is reduced. Moreover, less signaling occurs with the network as the PLMNs that were accepted earlier are prioritized over other PLMNs.

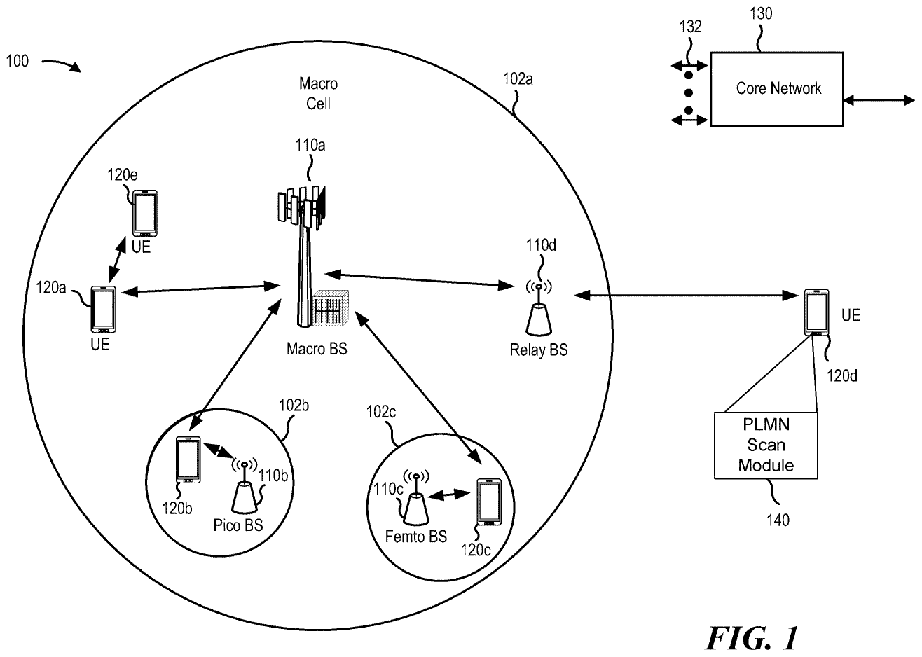

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (e.g., macro BSs, pico BSs, femto BSs, relay BSs, and/or the like). These different types of BSs may have different transmit power levels, different coverage areas, and different impact on interference in the wireless network 100. For example, macro BSs may have a high transmit power level (e.g., 5 to 40 watts) whereas pico BSs, femto BSs, and relay BSs may have lower transmit power levels (e.g., 0.1 to 2 watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions.

The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

The UEs 120 may include a PLMN scan module 140. For brevity, only one UE 120d is shown as including the PLMN scan module 140. The PLMN scan module 140 may configure pairs of radio access technologies (RATs) and frequency bands in response to detecting no preferred public land mobile network (PLMN) while the UE is roaming in a different country than a country where the UE was previously located. The PLMN scan module 140 may also scan one of the pairs of RAT/frequency band in a selected PLMN. The PLMN scan module 140 may further attempt registration on the selected PLMN in response to the scanning indicating a quality of the selected PLMN is above a threshold. The PLMN scan module 140 may store the selected PLMN in a list of successful PLMNs in response to successful registration.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet of things (IOT) devices, and/or may be implemented as narrowband (NB)-devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

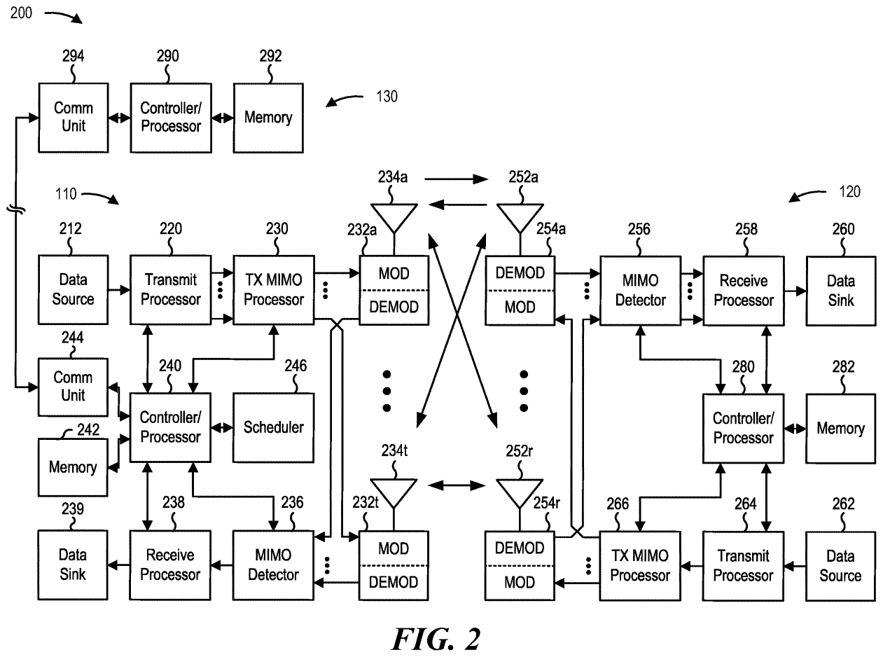

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for orthogonal frequency division multiplexing (OFDM) and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

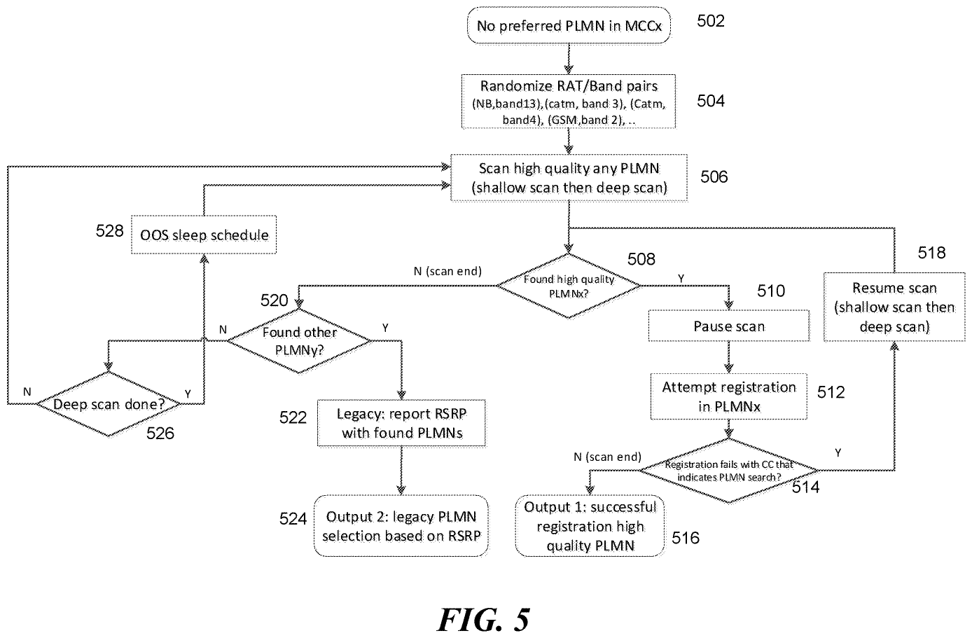

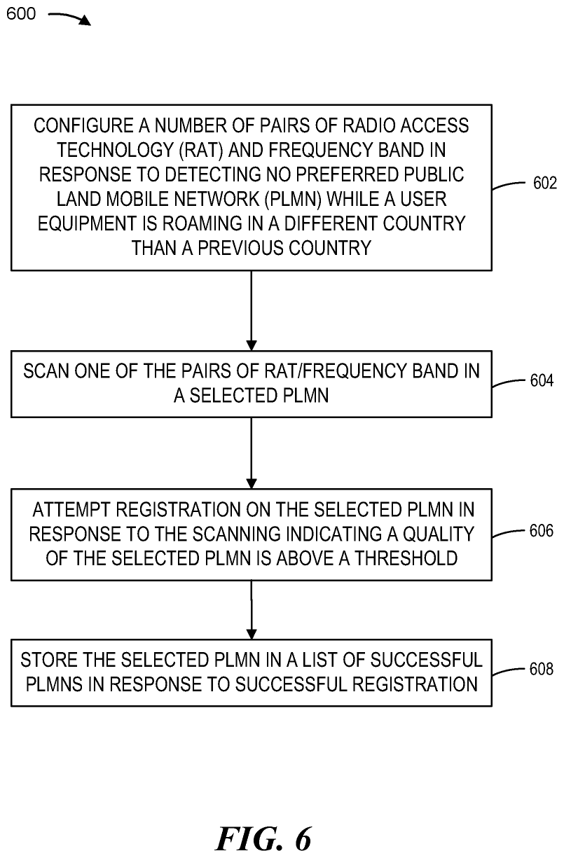

The controller/processor 240 of the base station 110, the controller/processor 280 of the UE 120, and/or any other component(s) of FIG. 2 may perform one or more techniques associated with PLMN scanning, as described in more detail elsewhere. For example, the controller/processor 240 of the base station 110, the controller/processor 280 of the UE 120, and/or any other component(s) of FIG. 2 may perform or direct operations of, for example, the processes of FIGS. 5 and 6 and/or other processes as described. Memories 242 and 282 may store data and program codes for the base station 110 and UE 120, respectively. A scheduler 246 may schedule UEs for data transmission on the downlink and/or uplink.

In some aspects, the UE 120 and/or base station 110 may include means for configuring, means for scanning, means for attempting, means for storing, means for randomly configuring, means for determining, means for detecting, and means for aborting. Such means may include one or more components of the UE 120 or base station 110 described in connection with FIG. 2.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, IoT devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

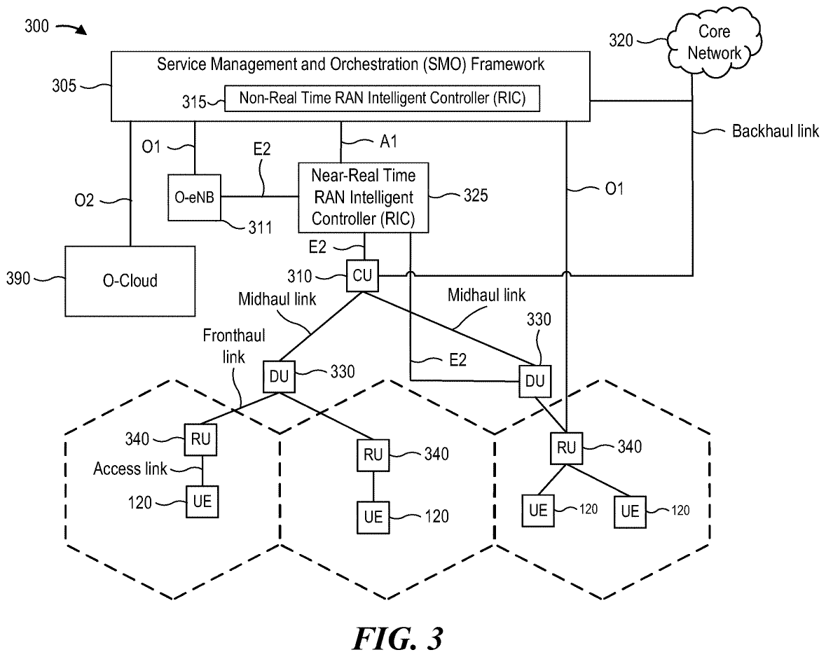

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUS 340.

Each of the units (e.g., the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., central unit-user plane (CU-UP)), control plane functionality (e.g., central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an Al interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

Internet of things (IoT) devices may include various types of devices, such as tracking devices. A tracking device may have sensor capabilities that track environmental conditions and locations of assets. These device are generally lightweight and low power. Some tracking devices may transmit geolocation data in real time.

In some scenarios, a tracker device moves from one region (e.g., mobile country code (MCC) or country) to another. For example, in the European Union, a tracking device may cross multiple regions in a single trip. Although the present description is with respect to tracker devices, the described techniques equally apply to any mobile device. Thus, the tracker devices will be referred to as user equipment (UE) throughout this specification.

When moving from one region to another, especially while recovering from an out-of-service (OOS) state or coming online after power up, scanning for a network may take a long time. The scanning may be lengthy, for example, when the UE is in a country while roaming or in a country with a worldwide MCC (e.g., 9xx) such that the UE does not have a preferred PLMN in this country. One reason the devices take a long time to camp on a PLMN in these scenarios is because of the lengthy procedures for scanning frequency bands. Another reason for the lengthy scan time is that the UE location (e.g., MCC) may have changed from a time when the UE enters an airplane mode, enters a low power mode (LPM), or goes out-of-service. Thus, when the UE powers up in a new area or moves from one country to another, the UE may take a long time to camp on a network.

Many network operators choose not to set up a preferred PLMN list. As a result, performing specification-based PLMN selection results in recovery delays registering with a network, especially when a frequency scanning sequence is not defined. As a result, registration attempts occur randomly in those PLMNs. Moreover, specification-based solutions may not be desirable as these types of solutions are developed based on a preferred PLMN configuration. Moreover, the specification does not account for the same device moving from one location to another, multiple times, with each move triggering random PLMN registration attempts. The specification-based solutions define scanning of the PLMNs in preferred order. For example, scanning begins with the last registered public land mobile network (RPLMN). If that scan is unsuccessful, the UE scans the equivalent home PLMN (EHPLMN), then the UE scans the user public land mobile network (UPLMN), then the operator public land mobile network (OPLMN), and then other PLMNs in random order. During the scan, even if the country changes, the specification requires completing the full scanning of the RPLMN before scanning another PLMN. Because the country has changed, however, it may not make sense to continue scanning for the RPLMN.

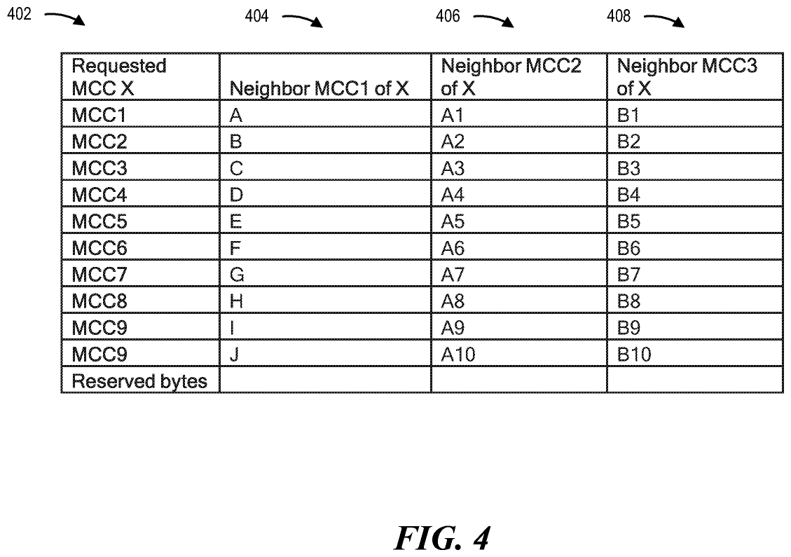

According to aspects of the present disclosure, the UE stores an extendible file system (EFS) in non-volatile memory, which helps the UE detect a county change based on neighbor countries. A configurable EFS is shown in the example of FIG. 4, where neighbors of a requested PLMN can be configured.

FIG. 4 is a table illustrating neighbor mobile country codes (MCCs), in accordance with various aspects of the present disclosure. In the example of FIG. 4, a first column 402 lists requested MCCs, which correspond to the current country where the UE is located, based on an RPLMN. Second, third, and fourth columns 404, 406, 408 list neighbor MCCs. For example, if the requested MCC corresponds to the US, the neighbor in the second column 404 may be an MCC of Mexico, and the neighbor in the third column 406 may be an MCC of Canada. If the UE is located in the current country (e.g., the MCC of column 1 402), or one of the neighboring countries (e.g., the MCC in second, third, or fourth columns 404, 406, 408), the UE is able to scan based on the detected countries.

In some aspects, the UE detects whether a country change has occurred after a certain duration. For example, the UE may detect whether a country change has occurred in response to expiration of a configurable timer, while performing a first round of scans. If any neighbors of the requested PLMN are found in the list, the UE continues the scan. If no neighbors are found from the configured EFS, the UE aborts the ongoing scan because the UE determines the country has changed and the UE is in a roaming scenario. Thus, unnecessary scanning is avoided.

If the UE is determined to be in a roaming scenario, the network access stratum (NAS) layer of the UE receives a report of PLMNs from a lower layer after expiration of a configurable timer. An example of a lower layer is the radio resource control (RRC) layer. That is, the PLMN report is received after each time out. If the reported PLMN from the lower layer matches a PLMN listed in a subscriber identification module (SIM) card, such as a configured operator public land mobile network (OPLMN) or user public land mobile network (UPLMN), the UE prioritizes the PLMN listed in the SIM card list as a preferred PLMN. SIM configured PLMNs may be found in devices such as mobile devices. The UE begins PLMN selection with all RATs on the preferred PLMN, if such a PLMN is provided.

In some cases, no preferred PLMN is provided. For example, the reported PLMNs may not be listed in a SIM card if the UE is a tracker device without a SIM card, rather than a mobile device with a SIM card. In another example, the lower layer did not report any PLMN that is an EHPLMN or OPLMN or UPLMN (e.g., network with which a roaming agreement exists). In these cases where no preferred PLMN exists, the UE restarts PLMN selection by randomizing the RATs and bands supported by the UE, for example, as configured by a call manager. The UE will then restart scanning based on the randomized RAT/band pairs. If service is found and the UE successfully registers on a PLMN, the successful PLMN is stored in a cache for later use, the next time the UE returns from an out-of-service state while roaming. If service is not found, the UE may enter an out-of-service state. More details of the scanning process will now be provided with respect to FIG. 5.

FIG. 5 is a flow diagram illustrating a method for public land mobile network (PLMN) scanning, in accordance with various aspects of the present disclosure. As shown in FIG. 5, at block 502, a UE, such a tracking device, determines that no preferred PLMN is available for the region (e.g., MCCx) in which the UE is located. For example, the UE may be roaming in a region for which no roaming agreement exists. Next, at block 504, the UE randomizes pairs of RATs and frequency bands for which the UE is configured. The UE creates RAT and band pairs, such as the RAT and band pairs provided in the example below, where narrowband IoT (NB), GSM, and LTE category M (Cat-m) RATs are enabled:

Pairs: (NB, band 13), (cat-m, band 3), (Cat-m, band 4), (GSM, band 2), (NB, band 6) When scanning the randomized RAT/frequency pairs, the UE may locate some PLMNs. For example, the RPLMN may be located. That is, the scan of the RAT/band pairs locates a number of PLMNs and if the RPLMN is found during the scan, the registration attempts begin with that RPLMN. At block 506, the non-access stratum (NAS) layer of the UE restarts PLMN selection with the RPLMN. The UE may initially perform a shallow scan where the signal to noise ratio (SNR) is level 0 or level 1. A shallow scan is designed for PLMNs with a moderate to good signal to noise ratio (SNR). If the RPLMN is determined to have a signal quality above a threshold, at block 508: YES, the PLMN is considered to be a high quality PLMN (e.g., PLMNx), the UE pauses the scan at block 510, and attempts to register on the RPLMN at block 512. If the registration is successful, at block 514: NO, the scan ends and the successfully registered high quality PLMN (e.g., PLMNx) is stored in a list of successful PLMNs in the cache. If the registration fails due to a cause code (CC) indicating registration failure (514: YES), at block 518, the UE resumes scanning, first performing a shallow scan and then performing a deep scan, where the SNR is level 2. A deep scan is designed for a worst case SNR scenario and takes longer than a shallow scan. The process then returns to block 508 where the NAS randomizes PLMNs reported by the lower layer and acquisition attempts continue until service is obtained on a selected PLMN or all RAT/band pairs are exhausted. The randomized PLMNs are reported by the RRC layer as part of the RAT/frequency band pairs.

If the UE successfully registers on the selected PLMN at block 516, then the NAS layer of the UE saves this PLMN to a list of successful PLMNs in a preferred PLMN (PPLMN) cache. When randomizing the PLMNs reported from the lower layer, the next time the UE is roaming and does not have a preferred PLMN, the UE prioritizes these previously successful PLMNs in the list over other non high quality (HQ) PLMNs. High quality PLMNs are non-preferred PLMNs, such as the EHPLMN, UPLMN, and OPLMN. The UE maintains a list of a configurable number of such unique successful PLMNs.

At block 508, if a high quality PLMN is not found, scanning ends and the UE determines if any other PLMNs are found (e.g., low quality PLMNs such as PLMNy), at block 520. If so (520:YES), at block 522, legacy reporting occurs where the UE lists the found PLMNs in reference signal receive power (RSRP) power order. At block 524, the UE performs legacy PLMN selection based on the RSRP of the low quality PLMNs found at block 520. If no other PLMNs are found (520:NO), at block 526, the UE determines whether a deep scan was performed. If not (526:NO), the UE performs a deep scan at block 506. If a deep scan was already determined to have been performed at block 526, at block 528, the UE operates in accordance with an out-of-service (OOS) sleep schedule and the process returns to block 506.

According to aspects of the present disclosure, once a country change is detected (e.g., border vs. no border country), PLMN selection time is improved for global MCCs or when a preferred PLMN list is not configured in a SIM card of the UE. In case the UE is in a border country, the scan may continue following the configured bands. For a non-border case, a cached PLMN list may be used to restart PLMN selection. For a country change (e.g., the non-border case) if no cached PLMN is present, supported MCC bands and RATs are randomized to provide an equal chance for all found PLMNs.

Aspects of the present disclosure enable fast recovery in cases when a UE moves from one country to other. As a result, a better end user experience and longer device battery life are achieved as the PLMN scanning time is reduced. Moreover, less signaling occurs with the network as the PLMNs that were accepted earlier are prioritized over other PLMNs.

As indicated above, FIGS. 3-5 are provided as examples. Other examples may differ from what is described with respect to FIGS. 3-5.

FIG. 6 is a flow diagram illustrating an example process 600 performed, for example, by a user equipment (UE), in accordance with various aspects of the present disclosure. The example process 600 is an example of improving the public land mobile network (PLMN) camping time for Internet of things (IOT) devices when roaming. The operations of the process 600 may be implemented by a UE 120.

At block 602, the user equipment (UE) configures pairs of radio access technologies (RATs) and frequency bands in response to detecting no preferred public land mobile network (PLMN) while the UE is roaming in a different country than a country where the UE was previously located. For example, the UE (e.g., using controller/processor 280, memory 282, and/or the like) may configure the pairs of RAT. In some aspects, the configuring comprises randomly configuring the pairs of RAT/frequency band. In some aspects, the UE is determined to be roaming in the different country based on a list of neighbor countries relative to a country associated with a last registered PLMN. In other aspects, the UE detects it is roaming in the different country, after a timer expires; and the UE aborts an ongoing initial scan in response to detecting the UE is roaming in the different country.

At block 604, the user equipment (UE) scans one of the pairs of RAT/frequency band in a selected PLMN. For example, the UE (e.g., using the antenna 252, DEMOD/MOD 254, MIMO detector 256, receive processor 258, TX MIMO processor 266, transmit processor 264, controller/processor 280, memory 282, and/or the like) may scan one of the pairs of RAT/frequency band. In some aspects, the selected PLMN is obtained from the list of successful PLMNs. The selected PLMN may be selected randomly when no PLMNs are in the list of successful PLMNs.

At block 606, the user equipment (UE) attempts registration on the selected PLMN in response to the scanning indicating a quality of the selected PLMN is above a threshold. For example, the UE (e.g., using the antenna 252, DEMOD/MOD 254, MIMO detector 256, receive processor 258, TX MIMO processor 266, transmit processor 264, controller/processor 280, memory 282, and/or the like) may attempt registration. At block 608, the user equipment (UE) stores the selected PLMN in a list of successful PLMNs in response to successful registration. For example, the UE (e.g., using controller/processor 280, memory 282, and/or the like) may store the selected PLMN. In some aspects, the UE is a tracker device.

### EXAMPLE ASPECTS

Aspect 1: A method of wireless communication by a user equipment (UE), comprising: configuring a plurality of pairs of radio access technology (RAT) and frequency band in response to detecting no preferred public land mobile network (PLMN) while the UE is roaming in a different country than a previous country; scanning one of the pairs of RAT/frequency band in a selected PLMN; attempting registration on the selected PLMN in response to the scanning indicating a quality of the selected PLMN is above a threshold; and storing the selected PLMN in a list of successful PLMNs in response to successful registration.

Aspect 2: The method of Aspect 1, in which the selected PLMN is obtained from the list of successful PLMNs.

Aspect 3: The method of Aspect 1 or 2, in which the selected PLMN is selected randomly when no PLMNs are in the list of successful PLMNs.

Aspect 4: The method of any of the preceding Aspects, in which the configuring comprises randomly configuring the pairs of RAT/frequency band.

Aspect 5: The method of any of the preceding Aspects, further comprising determining the UE is roaming in the different country based on a list of neighbor countries relative to a country associated with a last registered PLMN.

Aspect 6: The method of any of the preceding Aspects, further comprising: detecting the UE is roaming in the different country, after a timer expires; and aborting an ongoing initial scan in response to detecting the UE is roaming in the different country.

Aspect 7: The method of any of the preceding Aspects, in which the UE comprises a tracker device.

Aspect 8: An apparatus for wireless communication by a user equipment (UE), comprising: memory; and at least one processor coupled to the memory, the at least one processor configured: to configure a plurality of pairs of radio access technology (RAT) and frequency band in response to detecting no preferred public land mobile network (PLMN) while the UE is roaming in a different country than a previous country; to scan one of the pairs of RAT/frequency band in a selected PLMN; to attempt registration on the selected PLMN in response to the scanning indicating a quality of the selected PLMN is above a threshold; and to store the selected PLMN in a list of successful PLMNs in response to successful registration.

Aspect 9: The apparatus of Aspect 8, in which the selected PLMN is obtained from the list of successful PLMNs.

Aspect 10: The apparatus of Aspect 8 or 9, in which the selected PLMN is selected randomly when no PLMNs are in the list of successful PLMNs.

Aspect 11: The apparatus of any of the Aspects 8-10, in which the at least one processor is further configured to randomly configure the pairs of RAT/frequency band.

Aspect 12: The apparatus of any of the Aspects 8-11, in which the at least one processor is further configured to determine the UE is roaming in the different country based on a list of neighbor countries relative to a country associated with a last registered PLMN.

Aspect 13: The apparatus of any of the Aspects 8-12, in which the at least one processor is further configured: to detect the UE is roaming in the different country, after a timer expires; and to abort an ongoing initial scan in response to detecting the UE is roaming in the different country.

Aspect 14: The apparatus of any of the Aspects 8-13, in which the UE comprises a tracker device.

Aspect 15: An apparatus for wireless communication by a user equipment (UE), comprising: means for configuring a plurality of pairs of radio access technology (RAT) and frequency band in response to detecting no preferred public land mobile network (PLMN) while the UE is roaming in a different country than a previous country; means for scanning one of the pairs of RAT/frequency band in a selected PLMN; means for attempting registration on the selected PLMN in response to the scanning indicating a quality of the selected PLMN is above a threshold; and means for storing the selected PLMN in a list of successful PLMNs in response to successful registration.

Aspect 16: The apparatus of Aspect 15, in which the selected PLMN is obtained from the list of successful PLMNs.

Aspect 17: The apparatus of Aspect 15 or 16, in which the selected PLMN is selected randomly when no PLMNs are in the list of successful PLMNs.

Aspect 18: The apparatus of any of the Aspects 15-17, further comprising means for randomly configuring the pairs of RAT/frequency band.

Aspect 19: The apparatus of any of the Aspects 15-18, further comprising means for determining the UE is roaming in the different country based on a list of neighbor countries relative to a country associated with a last registered PLMN.

Aspect 20: The apparatus of any of the Aspects 15-19, further comprising: means for detecting the UE is roaming in the different country, after a timer expires; and means for aborting an ongoing initial scan in response to detecting the UE is roaming in the different country.

Aspect 21: The apparatus of any of the Aspects 15-20, in which the UE comprises a tracker device.

Aspect 22: A non-transitory computer-readable medium having program code recorded thereon, the program code executed by a processor and comprising: program code to configure a plurality of pairs of radio access technology (RAT) and frequency band in response to detecting no preferred public land mobile network (PLMN) while the UE is roaming in a different country than a previous country; program code to scan one of the pairs of RAT/frequency band in a selected PLMN; program code to attempt registration on the selected PLMN in response to the scanning indicating a quality of the selected PLMN is above a threshold; and program code to store the selected PLMN in a list of successful PLMNs in response to successful registration.

Aspect 23: The non-transitory computer-readable medium of Aspect 22, in which the selected PLMN is obtained from the list of successful PLMNs.

Aspect 24: The non-transitory computer-readable medium of Aspect 22, in which the selected PLMN is selected randomly when no PLMNs are in the list of successful PLMNs.

Aspect 25: The non-transitory computer-readable medium of any of the Aspects 22-24, in which the program code comprises program code to randomly configure the pairs of RAT/frequency band.

Aspect 26: The non-transitory computer-readable medium of any of the Aspects 22-25, in which the program code comprises program code to determine the UE is roaming in the different country based on a list of neighbor countries relative to a country associated with a last registered PLMN.

Aspect 27: The non-transitory computer-readable medium of any of the Aspects 22-26, in which the program code comprises: program code to detect the UE is roaming in the different country, after a timer expires; and program code to abort an ongoing initial scan in response to detecting the UE is roaming in the different country.

Aspect 28: The non-transitory computer-readable medium of any of the Aspects 22-27, in which the UE comprises a tracker device.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

1. A method of wireless communication by a user equipment (UE), comprising:
configuring a plurality of pairs of radio access technology (RAT) and frequency band in response to detecting no preferred public land mobile network (PLMN) while the UE is roaming in a different country than a previous country;
scanning one of the pairs of RAT/frequency band in a selected PLMN;
attempting registration on the selected PLMN in response to the scanning indicating a quality of the selected PLMN is above a threshold; and
storing the selected PLMN in a list of successful PLMNs in response to successful registration.

2. The method of claim 1, in which the selected PLMN is obtained from the list of successful PLMNs.

3. The method of claim 1, in which the selected PLMN is selected randomly when no PLMNs are in the list of successful PLMNs.

4. The method of claim 1, in which the configuring comprises randomly configuring the pairs of RAT/frequency band.

5. The method of claim 1, further comprising determining the UE is roaming in the different country based on a list of neighbor countries relative to a country associated with a last registered PLMN.

6. The method of claim 1, further comprising:
detecting the UE is roaming in the different country, after a timer expires; and
aborting an ongoing initial scan in response to detecting the UE is roaming in the different country.

7. The method of claim 1, in which the UE comprises a tracker device.

8. An apparatus for wireless communication by a user equipment (UE), comprising:
memory; and
at least one processor coupled to the memory, the at least one processor configured:
to configure a plurality of pairs of radio access technology (RAT) and frequency band in response to detecting no preferred public land mobile network (PLMN) while the UE is roaming in a different country than a previous country;
to scan one of the pairs of RAT/frequency band in a selected PLMN;
to attempt registration on the selected PLMN in response to the scanning indicating a quality of the selected PLMN is above a threshold; and
to store the selected PLMN in a list of successful PLMNs in response to successful registration.

9. The apparatus of claim 8, in which the selected PLMN is obtained from the list of successful PLMNs.

10. The apparatus of claim 8, in which the selected PLMN is selected randomly when no PLMNs are in the list of successful PLMNs.

11. The apparatus of claim 8, in which the at least one processor is further configured to randomly configure the pairs of RAT/frequency band.

12. The apparatus of claim 8, in which the at least one processor is further configured to determine the UE is roaming in the different country based on a list of neighbor countries relative to a country associated with a last registered PLMN.

13. The apparatus of claim 8, in which the at least one processor is further configured:
to detect the UE is roaming in the different country, after a timer expires; and
to abort an ongoing initial scan in response to detecting the UE is roaming in the different country.

14. The apparatus of claim 8, in which the UE comprises a tracker device.

15. An apparatus for wireless communication by a user equipment (UE), comprising:
means for configuring a plurality of pairs of radio access technology (RAT) and frequency band in response to detecting no preferred public land mobile network (PLMN) while the UE is roaming in a different country than a previous country;
means for scanning one of the pairs of RAT/frequency band in a selected PLMN;
means for attempting registration on the selected PLMN in response to the scanning indicating a quality of the selected PLMN is above a threshold; and
means for storing the selected PLMN in a list of successful PLMNs in response to successful registration.

16. The apparatus of claim 15, in which the selected PLMN is obtained from the list of successful PLMNs.

17. The apparatus of claim 15, in which the selected PLMN is selected randomly when no PLMNs are in the list of successful PLMNs.

18. The apparatus of claim 15, further comprising means for randomly configuring the pairs of RAT/frequency band.

19. The apparatus of claim 15, further comprising means for determining the UE is roaming in the different country based on a list of neighbor countries relative to a country associated with a last registered PLMN.

20. The apparatus of claim 15, further comprising:
means for detecting the UE is roaming in the different country, after a timer expires; and
means for aborting an ongoing initial scan in response to detecting the UE is roaming in the different country.

21-28. (canceled)
